(19) United States
(12) Patent Application Publication
(10) Pub. No.: US 2009/0216659 A1
(43) Pub. Date: Aug. 27, 2009

(54) Method and System for Assisting Cutomers in Making Purchase Decisions

(76) Inventor: Tracy L. Parker, Rogers, AR (US)

Correspondence Address: JAY M. SCHLOFF;INTELLIPEX PLLC, 30200 TELEGRAPH RD, SUITE 245, BINGHAM FARMS, MI, 48025, US

(21) Appl. No.: 12/038,215

(22) Filed: Feb. 27, 2008

(51) Int. Cl. G06Q 30/00; G06F 3/048

(52) U.S. Cl. 705/27; 715/766

(57) ABSTRACT

Disclosed are a method and a system for assisting a customer in making a purchase decision of a product. Information from the customer is received and a first virtual model is generated based on the information. A graphical image corresponding to the product is overlaid on the first virtual model for generating a second virtual model. The second virtual model is displayed for assisting the customer in making the purchase decision of the product.

### FIELD OF THE INVENTION

The present invention relates generally to customer service, and, more particularly, to a system for assisting customers in making purchase decisions.

### BACKGROUND OF THE INVENTION

Consumerism has resulted in offering multitude of choices to customers for each product to be purchased, often making the process of purchasing products a difficult experience. Typically, a customer may travel to a store to select a product of his suitability from various available products. The customer may also opt for alternate means, such as television programs and online shopping portals, for purchasing the products. Although these alternate means of purchasing the products may have certain advantages, such as elimination of time spent on commuting to the store, there exists a likelihood of the products being unacceptable to the customer, when they are received. Once the products are found unacceptable, the customer may have to return the products to the store, which may be discouraging for the customer.

In case of shopping for apparel such as garments, the customer may need to physically try a garment in a dressing room to determine whether the garment fits and its appearance is acceptable. This step may need to be repeated for all the garments chosen by the customer and hence may consume a substantial amount of time. Further, women may not prefer to physically try the garments in the dressing room as they may have their hair fixed or their make-up on while purchasing the garments. Moreover, women may be conscious of their weight and accordingly may not prefer to use the dressing room. Occasionally, customers may also bring their kids to the store and may not prefer leaving kids behind in the store, while physically trying the garments in the dressing room.

Further, a typical mode for purchasing a product at the store may involve making a payment to a cashier for purchasing the product. Such a mode of payment results in increasing time spent on purchasing the product as it may involve standing in a queue for making the payment to the cashier.

Accordingly, there exists a need for assisting customers in making purchasing decision. Further, there exists a need for enabling a customer to determine suitability of a product in a convenient and efficient manner. Also, there exists a need for enabling a customer to save time spent on purchasing a product, thereby increasing the satisfaction of the customer. Moreover, there also exists a need for facilitating ease of payment of the price of the product.

### SUMMARY OF THE INVENTION

In view of the foregoing disadvantages inherent in the prior art, the general purpose of the present invention is to provide a system configured to include all the advantages of the prior art, and to overcome the drawbacks inherent therein.

Accordingly, an object of the present invention is to assist a customer in making purchase decision.

Another object of the present invention is to enable a customer to determine suitability of a product in a convenient and efficient manner.

Yet another object of the present invention is to enable a customer to save time spent on purchasing a product for increasing the satisfaction of the customer.

Still another object of the present invention is to facilitate ease of payment of price of a product chosen by the customer.

In light of the above objects, in one aspect of the present invention, a method for assisting a customer in making a purchase decision is disclosed. Information from the customer is received and a first virtual model is generated based on the information. A graphical image corresponding to the product is overlaid on the first virtual model for generating a second virtual model. The second virtual model is displayed for assisting the customer in making the purchase decision of the product.

The second virtual model provides a visual representation of the suitability of the product as per the requirement of the customer. By observing the second virtual model, the customer may determine the suitability of the product without having to physically try multiple products. Thus, the customer may determine suitability of the product in a convenient manner. Moreover, the customer may also save time as the second virtual model precludes the need for the customer to physically try the multiple products.

In another aspect of the present invention, a system is provided for assisting a customer in making a purchase decision. The system comprises a customer input module, a model generation module, an image storage module and a display module. The customer input module is capable of receiving information provided by the customer. The model generation module is capable of generating a first virtual model based on the information. The model generation module is further capable of overlaying a graphical image corresponding to a product on the first virtual model for generating the second virtual model. The display module is capable of displaying the second virtual model for assisting the customer in making the purchase decision of the product. The customer input module is further configured to receive customer payment information for facilitating ease of payment of price of the product.

In yet another aspect of the present invention, a computer program product comprising instructions for assisting a customer in making a purchase decision is disclosed. Information from the customer is received and a first virtual model is generated based on the information. A graphical image corresponding to the product is overlaid on the first virtual model for generating a second virtual model. The second virtual model is displayed for assisting the customer in making the purchase decision of the product.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates an exemplary environment in which various embodiments of the present invention may be practiced;

FIG. 2 illustrates a system for assisting a customer in making a purchase decision, in accordance with an embodiment of the present invention;

FIG. 3 illustrates an exemplary user interface (UI) of the system of FIG. 2 for enabling a customer to make a purchase decision, in accordance with an embodiment of the present invention; and

FIG. 4 illustrates a flowchart depicting a method for assisting a customer in making a purchase decision, in accordance with an embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a method and a system for assisting customers in making purchase decisions, as shown and described. It is understood that various omissions and substitutions of equivalents are contemplated as circumstances may suggest or render expedient, but these are intended to cover the application or implementation without departing from the spirit or scope of the claims of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a method, a system and a computer program product for assisting a customer in making a purchase decision. Information from the customer is received and a first virtual model is generated based on the information received from the customer. A graphical image corresponding to a product is overlaid on the first virtual model for generating a second virtual model. The second virtual model is displayed for assisting the customer in making the purchase decision of the product.

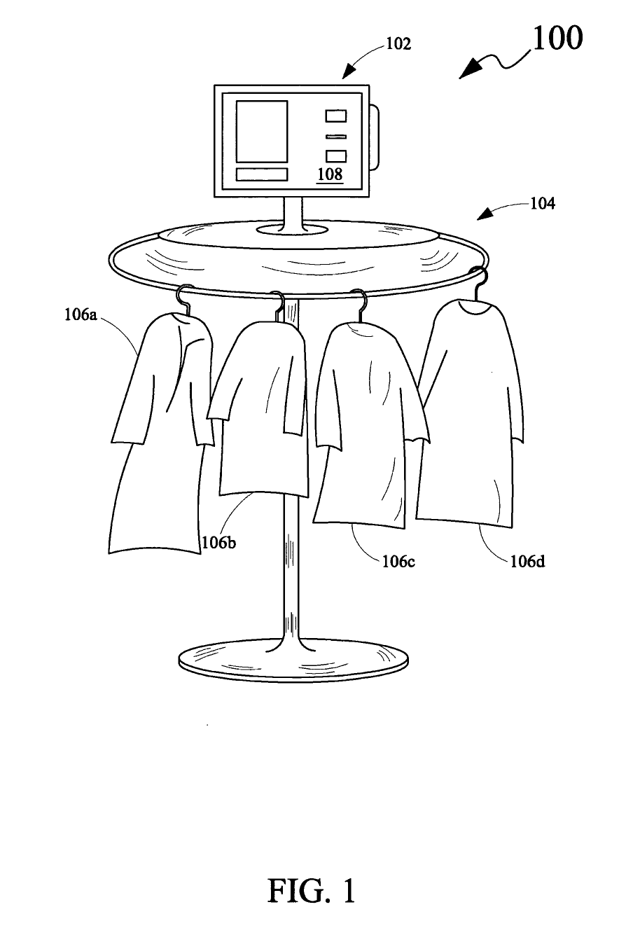

FIG. 1 illustrates an exemplary environment 100 in which various embodiments of the present invention may be practiced. The exemplary environment 100 includes a system 102 and a garment rack 104. The garment rack 104 includes suspension means for suspending a plurality of garments such as, a garment 106a, a garment 106b, a garment 106c and a garment 106d. The garments 106a, 106b, 106c and 106d are hereinafter collectively referred to as a plurality of garments 106.

In FIG. 1, the system 102 is mounted on the garment rack 104 as shown in FIG. 1. In one embodiment of the present invention, the system 102 may be remotely located from the garment rack 104. In another embodiment of the present invention, the system 102 can act as a server computing device configured to communicate with one or more data processing devices mounted on various garment racks.

It will be evident to those skilled in the art that the exemplary environment 100 may include a plurality of garment racks (not shown), such as the garment rack 104, for offering customers a variety of options for choosing garments such as, the plurality of garments 106. The exemplary environment 100 may also include a plurality of products (not shown) such as apparel accessories, furniture items and the like.

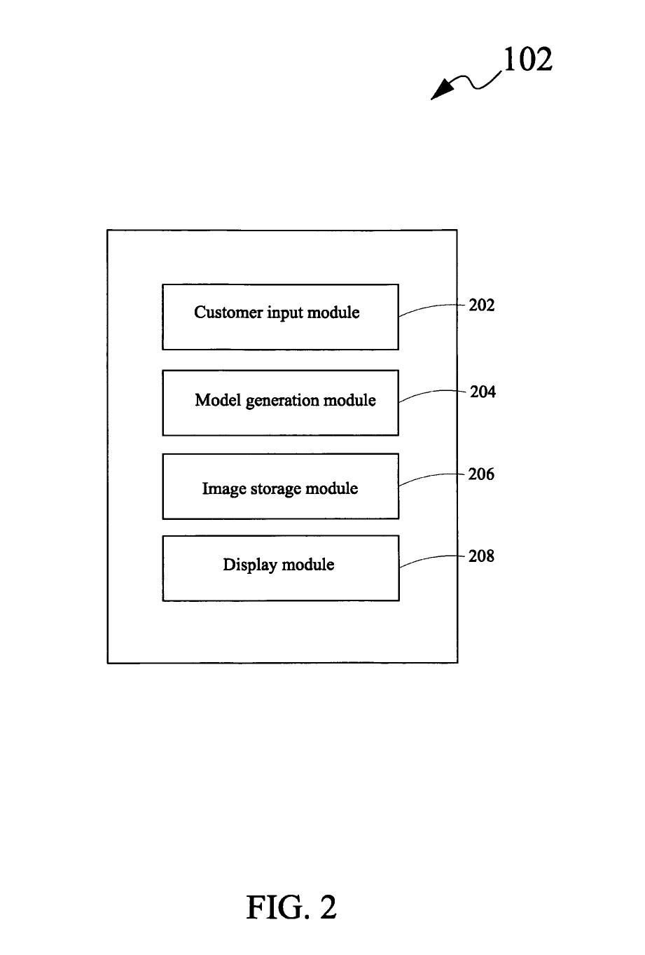

The system 102 includes a display screen 108 and a processor (not shown). The display screen 108 is configured to display a set of graphical images. Each graphical image of the set of graphical images corresponds to a product of the plurality of products being sold at the exemplary environment 100. For instance, a graphical image of the set of graphical images may be of the garment 106a or a furniture item (not shown), being sold at the exemplary environment 100. A customer (not shown) may provide information to the system 102 depending upon a specific requirement of the customer. For example, if the customer needs to purchase some garments, then the customer may provide the information such as, a customer height information, a customer weight information, a customer color information, a customer measurement, and the like. Further, if the customer needs to purchase a furniture item, then the customer may provide the information such as, a dimension of a customer's room, a color of customer's room, and the like. The set of graphical images corresponding to the plurality of products along with the information provided by the customer may be used by the system 102 to enable the customer to determine the suitability of the product, thereby assisting the customer in making the purchase decision of the product. The system 102 is explained in detail in conjunction with FIG. 2.

FIG. 2 illustrates the system 102 of FIG. 1 for assisting the customer in making the purchase decision, in accordance with an embodiment of the present invention. The system 102 includes a customer input module 202, a model generation module 204, an image storage module 206, and a display module 208. The customer input module 202 is capable of receiving information provided by the customer. The model generation module 204 is capable of generating a first virtual model based on the information. The image storage module 206 is capable of storing a set of graphical images (not shown). Each graphical image of the set of graphical images corresponds to a product of the plurality of products. The model generation module 204 is further capable of overlaying a graphical image corresponding to a product on the first virtual model for generating the second virtual model. The display module 208 is capable of displaying the second virtual model for assisting the customer in making the purchase decision of the product.

As explained in conjunction with FIG. 1, the information provided by the customer may include the customer height information, the customer weight information, the customer color information, the customer measurement, the dimension of the customer's room, and the color of customer's room and the like. In one embodiment of the present invention, the customer input module 202 may be implemented as a touch screen monitor configured with the display screen 108 for receiving information provided by the customer. It will be evident to those skilled in the art that the customer input module 202 may be also implemented as a keyboard, a mouse, a joystick or any such device for receiving information provided by the customer.

The model generation module 204 generates a first virtual model based on the information provided by the customer. The first virtual model may be a three dimensional (b 3D) representation of the information such as, a model of a human being, a model of an animal, a product or a model of a structure such as, a room. In one embodiment of the present invention, the model generation module 204 may generate a 3D model of the customer based on the information received such as, the customer weight information, the customer color information, the customer measurement, a customer bust size information, the dimension of the customer's room, and the color of customer's room and such other information. In another embodiment of the present invention, the model generation module 204 may generate a 3D model of a customer's room based on received information such as, room dimensions and color of the room.

The image storage module 206 stores the set of graphical images corresponding to the plurality of products. Examples of the image storage module 206 may include a Read Access Memory (RAM), a Read Only Memory (ROM), a flash memory or any programmable memory. The graphical images may be captured by an image capturing device such as, a digital camera, a camcorder and the like. The image storage module 206 may store multiple graphical images of a product for generating a 3D representation of the product. In one embodiment of the present invention, the set of graphical images corresponding to the plurality of products may be pre-stored in the image storage module 206. Further, each graphical image may be associated with a product identification code. The product identification code may uniquely identify the graphical image or the multiple graphical images corresponding to the product. In one embodiment of the present invention, the product identification code may be a barcode number associated with the product. In one embodiment of the present invention, the customer input module 202 may comprise a barcode scan module (not shown) for receiving the bar code number. The customer wishing to purchase the product may scan the barcode of the product to retrieve the graphical image corresponding to the product. Alternatively, the customer may input the barcode number using the customer input module 202 to retrieve the graphical image corresponding to the product.

The model generation module 204 is further capable of overlaying the graphical image corresponding to the product chosen by the customer onto the first virtual model to generate the second virtual model. The display module 208 displays the second virtual model. The second virtual model may be a 3D representation of the information with the graphical image of the product imposed on the 3D representation of the information. In one embodiment of the present invention, the second virtual model includes a graphical image of a garment chosen by the customer overlaid on a 3D model of the customer, thereby creating a virtual model of the customer wearing the garment. In another embodiment of the present invention, the second virtual model includes a graphical image of a sofa set chosen by the customer overlaid on a 3D model of the customer's room, thereby creating a virtual model of the customer's room with the sofa set.

In one embodiment of the present invention, the model generation module 204 is capable of rotating the second virtual model in one or more directions based on the customer input received via the customer input module 202. The customer input may be a clockwise rotation or an anticlockwise rotation of the second virtual model for determining the suitability of the product. Accordingly, the customer may view movements of the second virtual model through the display screen 108 and identify the fitness and the appearance of the product. In one embodiment of the present invention, the model generation module 204 may enable the customer to rotate the second virtual model through a 360 degree angle span in order to determine the suitability of the product.

Once the product such as the garment 106a is selected, the customer may purchase the garment 106a by providing a customer payment information to the customer input module 202. In one embodiment of the present invention, the customer input module 202 may be implemented as an electronic card reader in order to receive the customer payment information. Examples of the customer payment information may include an electronic card data such as, a debit card data or a credit card data, a biometric data or a bank account number. In one embodiment of the present invention, the system 102 may enable the customer to place an order for the product and provide a shipping address for delivering the product to the customer at the provided shipping address.

It will be evident to those skilled in the art that each of the modules of the system 102 such as the customer input module 202, the model generation module 204, the image storage module 206 and the display module 208 may be implemented as a hardware module, a software module, a firmware module, or any combination thereof. Furthermore, it will be obvious to those skilled in the art that the system 102 may include requisite electrical connections for communicably coupling the various modules of the system 102.

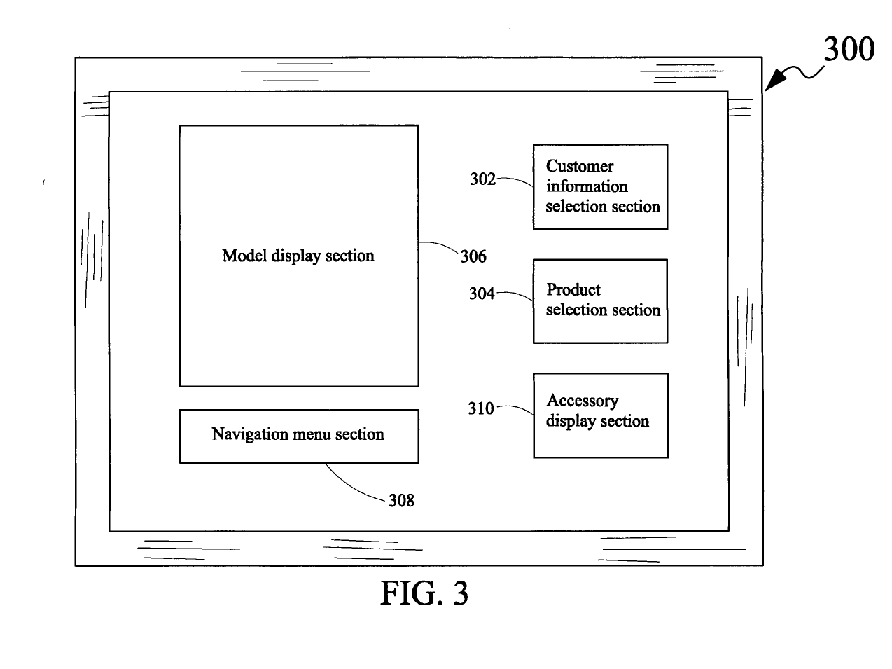

FIG. 3 illustrates an exemplary user interface (UI) 300 of the system 102 for assisting a customer in making a purchase decision, in accordance with an embodiment of the present invention. As explained in conjunction with FIG. 2, the customer input module 202 may be implemented as the touch screen monitor with the display screen 108. The display module 208 may configure the display screen 108 to provide the UI 300. The UI 300 displays a customer information selection section 302, a product selection section 304, a model display section 306, a navigation menu section 308 and an accessory display section 310.

The customer information selection section 302 includes one or more tabs for inputting the customer information such as a customer height, a customer weight, a customer body shape such as, slim or athletic, a customer color and the like. It will be evident to those skilled in the art that ranges for a height, a weight, a bust size, a chest size or any such other features may be provided in the one or more tabs for receiving the customer information. The customer may touch the display screen 108 using a human finger or a stylus for navigating through options provided through the one or more tabs in order to input the customer information. It will be evident to those skilled in the art that for purchasing products such as a furniture item, the customer information selection section 302 may include one or more tabs for inputting information such as customer room dimensions, customer room color and the like.

The product selection section 304 includes one or more tabs for inputting information such as a product identification number, a product color, a product size and the like. The customer information selection section 302 may allow the customer to scan the barcode for inputting the product identification information. A three dimensional representation of the information provided by the customer with the graphical image of the product selected by the customer overlaid on the 3D representation may be displayed in the model display section 306. The 3D representation may be moved in one or more directions or rotated by using the navigation menu section 308. The accessory display section 310 is configured to display at least one accessory corresponding to a chosen product. In one embodiment of the present invention, each product of the plurality of products may be linked with at least one accessory and a corresponding graphical image of the at least one accessory stored in the image storage module 206. On retrieving the graphical image corresponding to the product by using the product identification information, the graphical image corresponding to the at least one accessory may be displayed by the display module 208 on the UI 300.

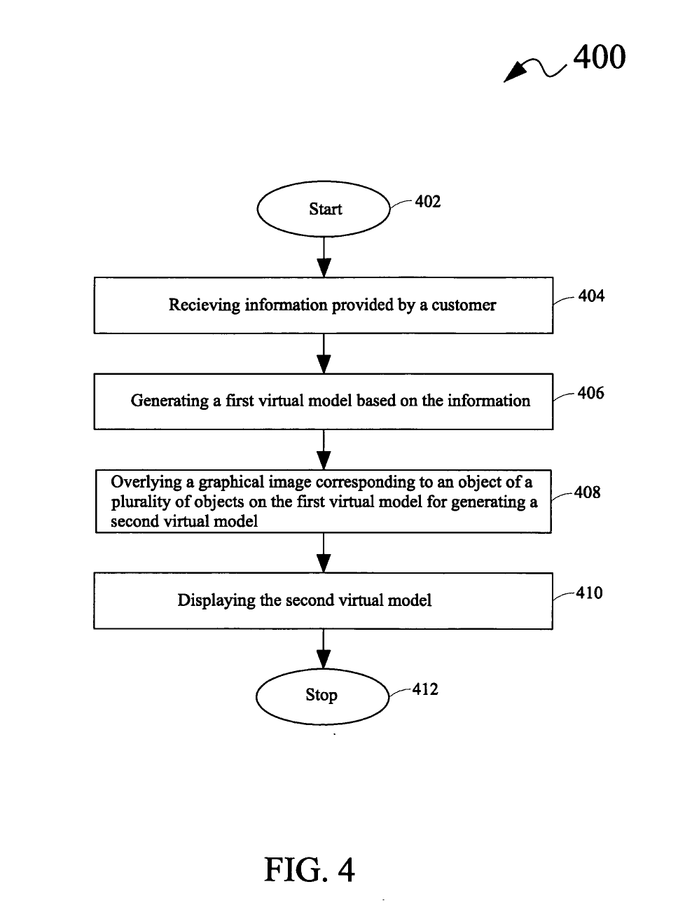

FIG. 4 illustrates a flowchart depicting a method 400 for assisting a customer in making a purchase decision. The method 400 starts at 402 with the customer pursuing one or more options of purchasing a product at an environment such as, the exemplary environment 100. At 404, customer information is received. At 406, a first virtual model is generated based on the information received from the customer. At 408, a graphical image corresponding to a product of the plurality of products is overlaid on the first virtual model for generating the second virtual model. At 410, the second virtual model is displayed to the customer for assisting the customer in making the purchase decision of the product. At 412, the method terminates with the customer making the purchase decision regarding the product.

As explained in conjunction with FIG. 1, the information may include at least one of the customer height information, the customer weight information, the customer color information, the customer measurement, the dimension of the customer's room and the color of the customer's room. A product of the plurality of products may be a garment, a furniture item, a garment accessory and the like. The graphical image corresponding to the product may be selected by receiving the product identification information of the product. The set of graphical images corresponding to the plurality of products may be stored in a storage module such as, the image storage module 206.

Further, as explained in conjunction with FIG. 2, the second virtual model may be rotated in one or more directions based on customer input for enabling the customer to determine the suitability of the product. The customer input may be a clockwise rotation or an anticlockwise rotation of the second virtual model for determining the suitability of the product. Once the customer is satisfied with the product and decides to purchase the product, a customer payment information may be received from the customer for facilitating easy payment of the price of the product. The customer payment information may one of the electronic card data and the biometric data. Further, at least one accessory associated with the product may be displayed for assisting the customer in making the purchase decision.

The system explained in conjunction with FIGS. 2 and 3 and the method explained in conjunction with FIG. 4 for assisting customers in making the purchase decision may be advantageous to the customers as they enable the customers to determine the suitability of the product in a convenient manner. In case of garments, the method and system preclude the need for the customers to physically try the garments for determining suitability of the garments. This may be especially advantageous to women as they may have their hair fixed or make-up on or may be accompanied with children. Further, precluding time spent on physically trying garments may enable the customer to save time spent on purchasing the product, thereby increasing the satisfaction of the customer. Moreover, payment of the price of the product by providing the customer payment information facilitates time saving as it precludes standing in queues for making the payment. Further, vendors of the products may benefit from the satisfaction of the customer which may result in repeat business for the vendors. Displaying accessories along with products may also serve to be especially advantageous for promotion of products and services for the vendor.

As described above, the embodiments of the present invention may be embodied in the form of computer-implemented processes and apparatuses for providing multimedia content to customers at a vendor location. Embodiments of the present invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the present invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present invention. When implemented on a general-purpose microprocessor, the computer program code segments configure the microprocessor to create specific logic circuits.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims of the present invention.

1. A method for assisting a customer in making a purchase decision, the method comprising:
receiving information provided by the customer at a customer input module;
generating a first virtual model by a model generation module based on the information;
overlaying a graphical image of a set of graphical images on the first virtual model for generating a second virtual model by the model generation module, the graphical image corresponding to a product of a plurality of products; and
displaying the second virtual model for assisting the customer in making the purchase decision of the product at a display screen.

2. The method of claim 1, wherein the information comprises at least one of a customer height information, a customer weight information, a customer color information, a customer measurement, a dimension of a customer's room and a color of a customer's room.

3. The method of claim 1, wherein the product is a garment.

4. The method of claim 1, wherein the product is a furniture item.

5. The method of claim 1, further comprising receiving a product identification information of the product at the customer input module, the product identification information capable of identifying the graphical image corresponding to the product.

6. The method of claim 1, further comprising storing the set of graphical images at an image storage module, each graphical image of the set of graphical images corresponding to a product of the plurality of products.

7. The method of claim 1, further comprising rotating the second virtual model in one or more directions on the display screen based on customer input.

8. The method of claim 1, further comprising receiving a customer payment information provided by the customer at the customer input module, wherein the customer payment information comprises one of an electronic card data and a biometric data.

9. The method of claim 1, further comprising displaying at least one accessory associated with the product at the display screen.

10. A system for assisting a customer in making a purchase decision, the system comprising:
at least one processor controlled by stored programmed instruction, the at least one processor adapted to
receive an information provided by the customer at a customer input module;
generate a first virtual model using a model generation module based on the information, the model generation module capable of overlaying a graphical image of a set of graphical images on the first virtual model for generating a second virtual model, the graphical image corresponding to a product of a plurality of products; and
display the second virtual model to the customer for assisting the customer in making the purchase decision of the product at a display screen.

11. The system of claim 10, wherein the processor is further adapted to store the set of graphical images at an image storage module, each graphical image of the set of graphical images corresponding to a product of the plurality of products.

12. The system of claim 10, wherein the processor is further adapted to receive a product identification information of the product at the customer input module, the product identification information capable of identifying the graphical image corresponding to the product.

13. The system of claim 12, wherein the product identification information is a barcode number.

14. The system of claim 10, wherein the second virtual model is configured as a three dimensional representation of the information.

15. The system of claim 10, wherein the processor is further adapted to rotate the second virtual model in one or more directions on the display screen based on customer input.

16. The system of claim 10, wherein the processor is further adapted to receive a customer payment information provided by the customer at the customer input module.

17. The system of claim 16, wherein the customer payment information comprises one of an electronic card data and a biometric data.

18. The system of claim 10, wherein the processor is further adapted to display at least one accessory associated with the product at the display screen.

19. A computer program product embodied on a computer readable medium for assisting a customer in making a purchase decision, the computer program product comprising program modules having instructions for:
receiving information provided by the customer;
generating a first virtual model based on the information;
overlaying a graphical image of a set of graphical images on the first virtual model for generating a second virtual model, the graphical image corresponding to a product of a plurality of products; and
displaying the second virtual model for assisting the customer in making the purchase decision of the product.

20. The computer program product according to claim 19, further comprising instructions for receiving a product identification information of the product, the product identification information capable of identifying the graphical image corresponding to the product.
